(19) United States
(12) Patent Application Publication
(10) Pub. No.: US 2005/0175105 A1
(43) Pub. Date: Aug. 11, 2005

(54) Block matching method for video compression

(75) Inventors: Ren-Hao Gu, Hsinchu (TW); Yuh-Feng Hsu, Chupei City (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 10/991,495

(22) Filed: Nov. 19, 2004

(30) Foreign Application Priority Data
Feb. 6, 2004 (TW) 93102712

(51) Int. Cl. H04N 7/12

(52) U.S. Cl. 375/240.24; 375/240.12

(57) ABSTRACT

The present invention discloses a block matching method for video compression. Wherein, the video frame currently under process is referred as first frame, and the reconstructed frame obtained from the result of the previous process is referred as second frame. The block matching method of the present invention is able to spot a MB on the second frame using a specified algorithm that the SAD of the spotted MB is the smallest while comparing with a designated MB of the first frame. The characteristic of the method of the present invention can be described as following: While simultaneously searching a plurality of points on the second frame, the threshold SAD can be defined as multiplying the minimal PSAD of each comparison by a parameter such that the threshold SAD can be used for determining the next search location among the plural points, that is, the next search location is the point with minimal SAD and can be found by rejecting the points with PSAD larger than an initial difference and keeping the points with PSAD smaller than the initial difference.

### 1.FIELD OF THE PRESENT INVENTION

The present invention generally relates to a block matching method, and more particularly, to a block matching method using sort decision and factor decision.

### 2.BACKGROUND OF THE PRESENT INVENTION

Digital video data in uncompressed format usually occupies a great amount of memory. Therefore, it is compressed so that it can be easily transmitted or stored. Since only the part of video data that be rarely sensed by human is removed after compression, the image quality of the decompressed video data is thus less degraded. More particularly, there are billions of colors in natural and human can only sense 1024 among them. As human cannot distinguish the fine difference between similar colors, there is no need in keeping all the colors. Moreover, redundant information among neighboring images that is captured in a very short period of time could be also found. Accordingly, for a film with sampling frequency of 30 frames per second, it is not necessary to store all of the video data representing an object if the object generally appears at successive frames of the same spot.

During the data compressing operation, the part of video data that cannot be sensed by human is abandoned. The compression ratio for standard digital video data is 5:1, and a compression ratio of 100:1 is also applicable for some video formats. However, as the compression ratio gets higher, more data is abandoned. Therefore, if the amount of abandoned video data is too large, the image quality degradation will become very significant and the decompressed video data will exhibits poor image quality.

The compressed video data is composed of a series of still frames, and thus temporal redundancy occurs due to considerable temporal correlation between adjacent frames. Furthermore, spatial redundancy occurs due to considerable spatial correlation between adjacent pixels. To eliminate the temporal redundancy, a motion estimation unit and a motion compensation unit in a video encoder could be used. Regarding to the spatial redundancy, a texture-coding unit with an optional shape-coding unit could be performed. In the present invention, a block matching method is used for the motion estimation unit so as to find Motion Vectors (MV) by comparing the Macro Blocks (MB) in adjacent frames.

FIG. 1 shows the block matching method to find the best matched MB by using a motion estimation unit. In the method, a current MB on the current frame at time T is compared to a plurality of MB's on the previous frame at time T-1 in a predefined sequence so as to find the best matched MB for the current MB. The best matched MB is usually determined by SAD (Sum of Absolute Different) calculation, which is shown below,

$$SAD ( x , y , u , v ) = {\sum }_{x = 0}^{N - 1} {\sum }_{y = 0}^{N - 1} \vert {I}_{n} ( x , y ) - {I}_{n - 1} ( x + u , y + v ) \vert$$

The whole search process generally causes heavy computations. Using the full search method with a search range of 32×32 pixels as an example. An MB of 16×16 pixels should be moved and matched on the search range to complete the whole search. At each location, 16×16 operations are required to obtain the SAD while comparing the current MB to the MB's of the previous frame. Therefore, the best matched MB having the smallest SAD could be obtained from all of the 32×32 block-matching operations after finishing totally 32×32×16×16 calculations.

The block matching operation between two adjacent frames generally occupies two thirds of the total calculation of a video encoder when using the full search. If it is required to perform all block matching operations at each location throughout the search range of the previous frame, the block-matching algorithm will require a great amount of calculation and adversely affects video compression for all frames. In this regard, there are algorithms of prior arts capable of minimizing the required calculation and speeding up the operation to find the best matched MB.

FIG. 2A and FIG. 2B show a kind of fast block matching operation known as Normalized Partial Distortion Search (NPDS) algorithm according to the prior art. Following the arrows shown in FIG. 2A, NPDS performs a spiral search sequence to find the best matched MB between a current MB 210 and the previous frame 200. For each block matching operation, the MB 210 is divided into 16 sections. The SAD value is then obtained by summing up from section 1 to 16. An early termination decision is used after adding a new section, if the current SAD is larger than the minimum SAD obtained by previous block matching operation, so as to facilitate rejecting in early stage some sections of calculation where it is less possible to be the best matched MB during the search sequence.

For example, as the search starts from point a on the previous frame 200, the SADₐ is first calculated by comparing all 256 pixels of the current MB 210 with those of point a, and is then stored into a register as the minimum SAD. Following the trace from point a to point b, the SAD_{b} is calculated so as to determine whether point b is a better matched MB than a or not.

More particularly, the SAD_{b} is calculated in a different way from that at point a. That is, the current MB at point b is first divided into 16 subgroups labeled from 1 to 16 correspondingly as shown in FIG. 2B. Partial SAD (PSAD) of the subgroup 1 is calculated first and compared to the one sixteenth of the SADₐ (referred to as SADₐ/16 hereinafter). If the PSAD of the subgroup 1 is smaller than the SADₐ/16, the PSAD of the subgroup 2 is calculated. This operation goes on until the PSAD of subgroup 16 is obtained, such that the SAD_{b} can be obtained from those PSAD's. However, if the PSAD of the subgroup 1 is larger than the SADₐ/16, the calculation for the other subgroups are canceled, thus rejecting point b from being a candidate of the best matched MB. The search process then proceeds to the next point following the arrow as shown in FIG. 2A. In this regard, after finishing all the searches following the arrow shown in FIG. 2A, the best matched MB can be found with less calculation required.

Although the NPDS algorithm is capable of rejecting some points of the previous frame as describe above, the spiral searching pattern as shown in FIG. 2A still requires a longer time because the whole search range has to be searched.

Another kind of conventional method capable of speeding up searching is the diamond search. FIG. 3A, FIG. 3B and FIG. 3C show the diamond search algorithm for block matching method according to the prior art. As seen in FIG. 3A, each SAD at the 9 points forming a diamond centering at point a on a previous frame 300 is calculated.

After all of the 9 SAD's in FIG. 3A are obtained, the point with the smallest SAD can be detected and referred to as point b, such that point b will be regarded as the diamond center for the next search. As seen in FIG. 3B and FIG. 3C, both diamonds have some overlapped points those SAD's are already known, and thus some duplicated calculation could be saved. Using the diamond search algorithm, the best matched MB is found while the center point of a diamond has the smallest SAD comparing to the other eight points, and the center point of the diamond formation is the location of the best matched MB.

Although the diamond search algorithm can speed up the searching process for block matching, the calculation of PSAD will increase the amount of calculation.

In view of the above description, the NPDS and diamond search algorithm respectively has its pros and cons, and an improved method is needed.

Therefore, the present invention provides a block matching method for video compression capable of reducing the amount of calculation and speeding up search of the best matched MB during video data compression.

### SUMMARY OF THE PRESENT INVENTION

The primary object of the present invention is to provide a block matching method for video compression, characterized in that the coordinate system is categorized into the frame coordinate identifying the location of MB's on the video frame and the pixel coordinate identifying the location of pixels in a MB. The video frame currently under process is referred to as a first frame, and the reconstructed frame obtained from the result of the previous process is referred to as a second frame. The block matching method of the present invention is able to spot a MB on the second frame using a specified algorithm that the SAD of the spotted MB is the smallest while comparing with a designated MB of the first frame.

The present invention is characterized in that, while simultaneously searching a plurality of points on the second frame, a threshold SAD can be defined by multiplying the minimal PSAD of each comparison by a parameter such that the threshold SAD can be used for determining the next search location among the plural points. That is, the next search location is the point with the minimal SAD and can be found by rejecting the points with the PSAD larger than an initial difference and keeping the points with the PSAD smaller than the initial difference.

In order to obtain the PSAD, a designated MB of the first frame is first divided into several subgroups each with the same amount of pixels distributed homogeneously therein, and then, each subgroup is numbered and compared with a specified location of the second frame so as to obtain the PSAD of the designated MB, where the SAD of the designated MB is the sum of all PSADs thereof.

The method described above can be combined with the foregoing diamond search algorithm so as to speed up search. The abovementioned block matching method is performed on a first group of the second frame for detecting a second location with minimal SAD in the first group, where the first group is a diamond formation centering at a first location on the second frame, and the diamond formation is composed of, but not limited to, 9 points. The abovementioned block matching method is also performed on a second group for detecting a third location with minimal SAD in the second group, where the second group is a diamond formation centering at the second location, and so forth.

If the location with minimal SAD is at the center of the current diamond, the process ends and the best matched MB is at the center of the diamond.

In a preferred embodiment of the present invention, the parameter is adjusted according to the required compression quality and speed, i.e. the smaller the parameter is, the faster the compression speed can be, and vice versa.

Another object of the present invention is to provide a block matching method employing sort decision, characterized in that, while simultaneously searching a plurality of points on the second frame, sorting the plural PSADs calculated based on each location and accepting only a designated number of points with smaller PSAD as candidates for next calculation.

To sum up, the present invention provides a block matching method for video compression, capable of using sort decision and factor decision with SAD calculation for reducing the amount of calculation and speeding up search during video compression.

### BRIEF DESCRIPTION OF THE DRAWINGS

FIG. 1 is a block diagram showing a block matching method for finding a best matched MB by using a motion estimation unit.

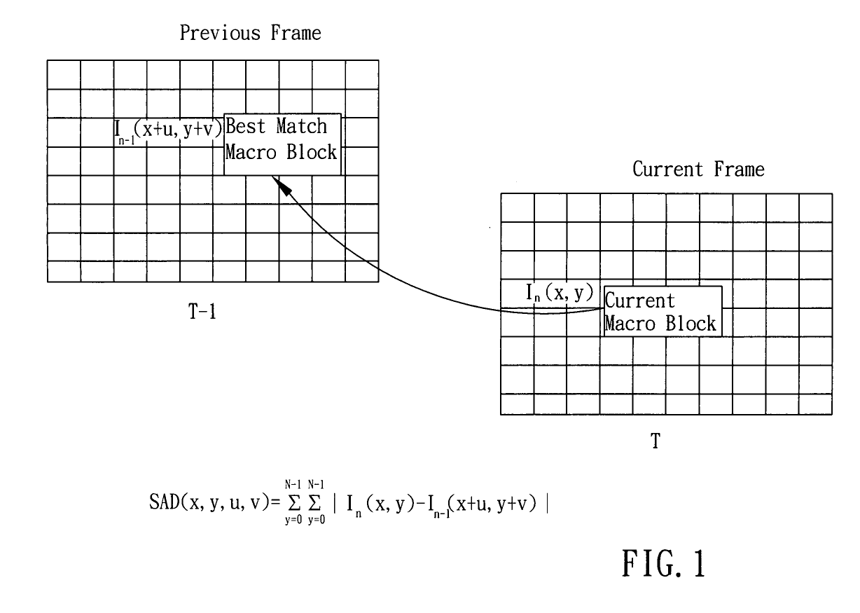

FIG. 2A and FIG. 2B are representations showing a normalized partial distortion search (NPDS) algorithm for block matching method according to the prior art.

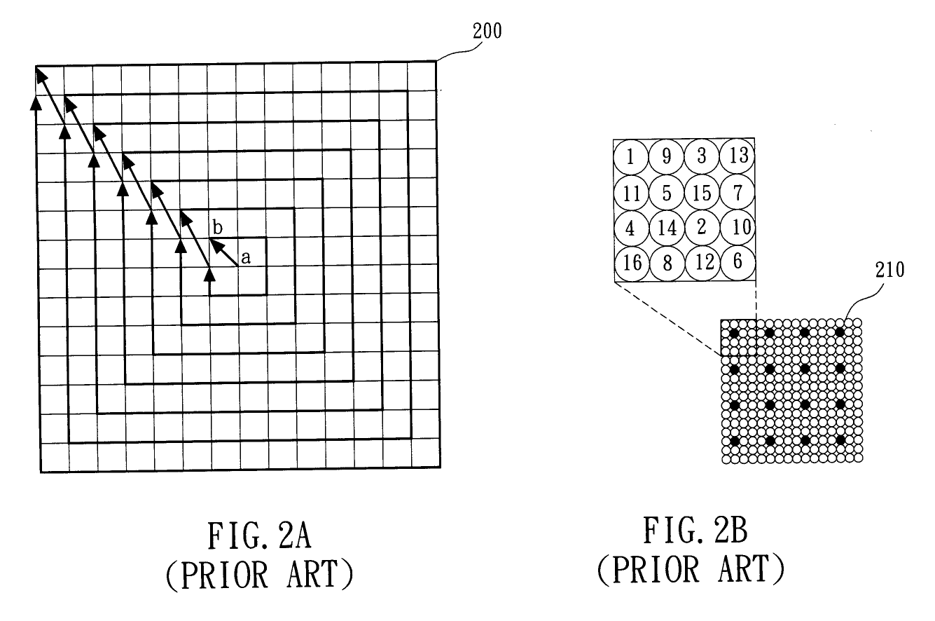

FIG. 3A-FIG. 3C is a block diagram showing a block matching method using the diamond search algorithm.

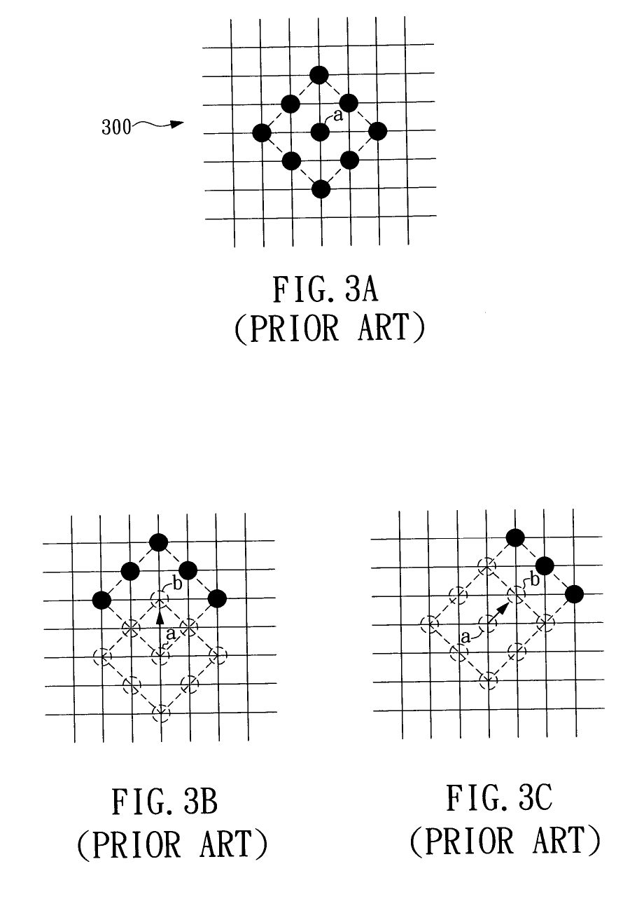

FIG. 4 is a schematic diagram of distributed access sequence.

FIG. 5 is a profile of PSAD sum after being sampled by distributed access sequence.

FIG. 6 is a diagram showing the relationship between the search position and the PSAD.

FIG. 7 is a flow chart of the block matching method of the present invention.

FIG. 8 is a graph illustrating the average calculations of the present invention and prior arts.

FIG. 9A and FIG. 9B are diagrams showing compression ratio v.s. PSNR.

FIG. 10 is a schematic diagram illustrating QP and computing power.

FIG. 11A and FIG. 11B are respectively a diagram showing compression ratio v.s. PSNR of the present invention and a diagram showing compression ratio v.s. PSNR of the diamond search algorithm.

### DESCRIPTION OF THE PREFERRED EMBODIMENT

The present invention discloses a block matching method for video compression capable of rapidly locating a best matched MB by changing the PSAD sampling algorithm of each search location, such that the present invention can have a small amount of calculation and faster searching speed comparing to the NPDS and the diamond search algorithm.

To further understand and recognize the fulfilled functions and structural characteristics of the present invention, several preferable embodiments cooperating with detailed description are presented as follows.

Statistically, the pixel variations between two successive video frames are not random. Thus, the profile of SADs based on the PSADs acquired by distributed accessing is linear. Therefore, according to the linearity of the SAD profile, it is possible to predict the SAD of a specified location, such that it is possible to determine whether the specified location is the location of the best matched macro clock or not.

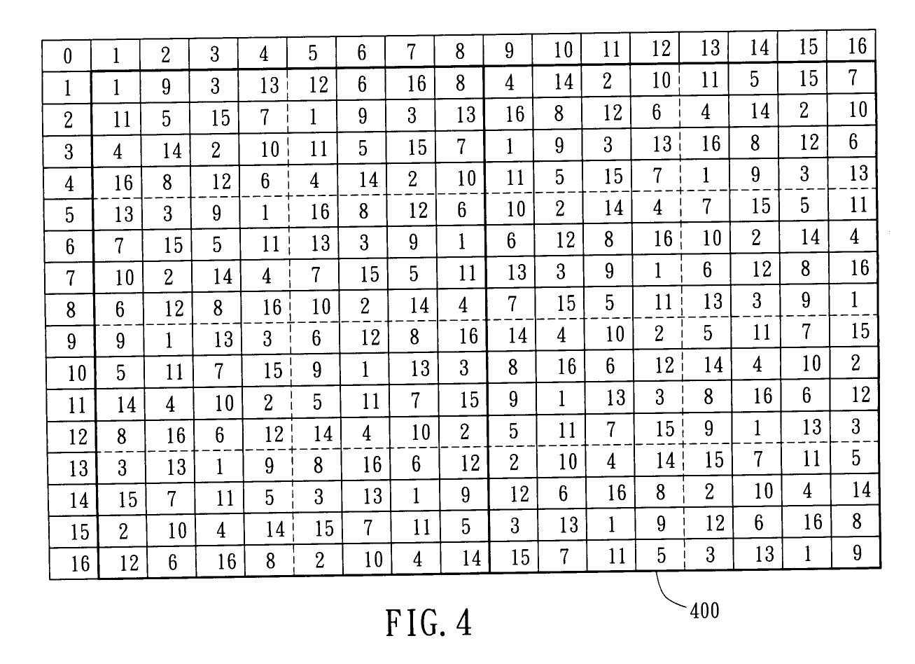

FIG. 4 is a schematic diagram of distributed access sequence. The MB 400 is composed of 16×16 pixels, and each pixel therein is numbered for distributed accessing while using the MB 400 as a reference for searching a best matched MB on a reconstructed frame. The PSAD is calculated according to the distributed access sequence; and in addition, SAD can be acquired by accumulating the PSADs.

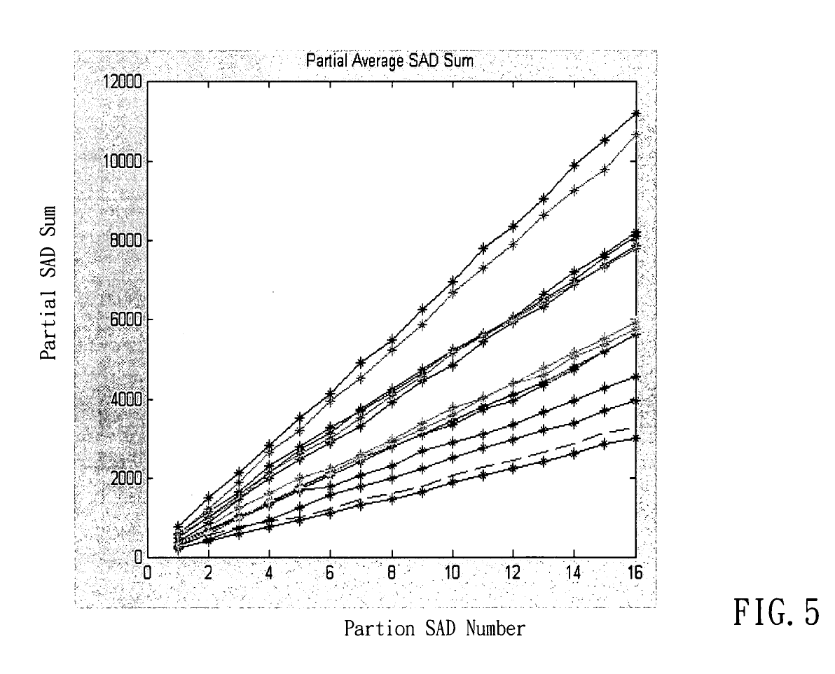

FIG. 5 is a profile of PSAD sum after being sampled by distributed access sequence. As to be seen in FIG. 5, the profile of PSAD sum is linearly distributed. In this regard, it is reasonable to assume that if the pixel numbered as 1 has the minimal PSAD. Then, according to the linearity of the PSAD sum profile, this SAD, which is the sum of PSADs, is the most probably minimal. Therefore, it is possible to determine the SAD of every location on the reconstructed frame without having to calculate the PSADs of pixels numbered from 1 to 16, and eventually predict the location of the best matched MB. The profile of SADs based on the PSADs acquired by distributed accessing is almost linearly distributed. In addition, certain criteria can be used for checking the candidates of the best matched MB during each PSAD comparison so that the speed performance can be improved.

According to the above description, the block matching method of the present invention combines the method of distributed accessing and the diamond search algorithm. Thus it can reject the less possible candidates rapidly and spot the most probable candidate of the best matched MB, so as to reduce the amount of calculation and improve speed performance. Moreover, it can dynamically adjust the parameter according to the available calculation power and the demanding compress quality.

In a preferred embodiment of the present invention, the diamond search algorithm enables a PSAD calculation to be performed on the diamond formation of 9 locations on a second frame simultaneously. The diamond search algorithm combined with some restriction criteria these are able to accelerate the rejection of less probable candidates of the best matched MB.

In a preferred embodiment of the present invention, factor decision is employed as the restriction criteria. The block matching method employing the factor decision is featured as follows: While simultaneously searching a diamond formation of 9 points on the second frame, the threshold SAD can be defined as multiplying the minimal PSAD of a parameter such that the threshold SAD can be used for determining the next search location among the plural points. That is, the next search location is the point with minimal SAD and can be found by rejecting the points with PSAD sum larger than threshold SAD and keeping the points with PSAD sum smaller than the threshold SAD.

Wherein, the parameter is adjusted based on the required speed performance and the compression quality. That is, the smaller the parameter is, the faster the searching speed can be, and vice versa. The formula of the threshold SAD is represented as follows:
Threshold SAD=f(k)×{min{SAD}+offset}

where k represents the number of calculation during the process, and
f(k) represents the parameter corresponding to k.
   In this regard, the block matching method of the present invention is able to adjust the search speed, i.e. adjust the compression ratio accordingly, based on the profile of f(k).

Therefore, while simultaneously searching on a diamond formation of 9 points on the second frame, the threshold SAD can be defined as f(k)×{min{SAD}+offset }.

In addition, when NLO(x,y) represents the center point of the diamond formation, and NL1˜NL8 represents the other eight points, and PSAD is defined as follows:

$$PSAD ( k , x , y , u , v ) = {\sum }_{k = 0}^{d} \{ {{\sum }_{x = 0} {\sum }_{y = 0}}^{( N - 1 ) / d ( n - 1 ) / d} \vert {I}_{n} ( t ( x ) , t ( y ) ) - {I}_{n - 1} ( t ( x + u ) , t ( y + v ) ) \vert \}$$

where x,y is the coordinate of a MB
t( ) is the function of distributed access sequence;
N represents the size of the MB;
k represents the number of distributed accessing;
d represents the total number of distributed accessing;
Iₙ(x) is the image function at time t;
Iₙ₋₁ is the image function at time t−1; and P1 u and v represent the location of diamond search.
   The block matching method can be provided by combining the diamond search algorithm with the abovementioned factor decision as follows:
A. Comparing the threshold SAD with PSAD0˜PSAD8 so as to determine the candidates for next search. If a location with PSAD sum among the PSAD0˜PSAD8 is larger than the threshold SAD, then the location is posted as less probable location and the following PSAD of that location will not be calculated further. If a location with PSAD sum among the PSAD0˜PSAD8 is smaller than the threshold SAD, then the location is posted as probable location and the process proceeds to step B.
B. Calculating the following PSADs of the probable locations and adding the calculated PSAD to be PSAD sum, and then repeating the step A until the location with minimal SAD is spotted.

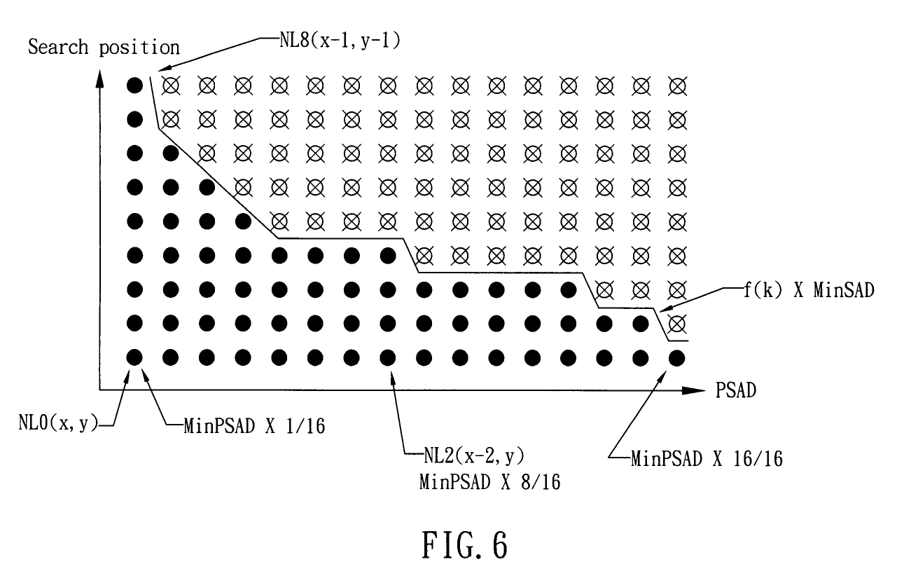

The block matching method combining the diamond search algorithm with the factor decision is able to calculate PSAD by distributed access sequence and simultaneously speed up the candidate rejection operation. FIG. 6 is a diagram showing the relationship between the search position and the PSAD. As seen in FIG. 6, the threshold SAD is the deciding factor affecting the amount of locations in the diamond formation to be rejected or accepted as candidate. When the parameter is increased, the amount of points in the diamond formation to be accepted as candidates will increase accordingly, and vice versa. Therefore, by adjusting the parameter, the block matching method is able to reject a certain number of points in a diamond so as to reduce the PSAD calculation.

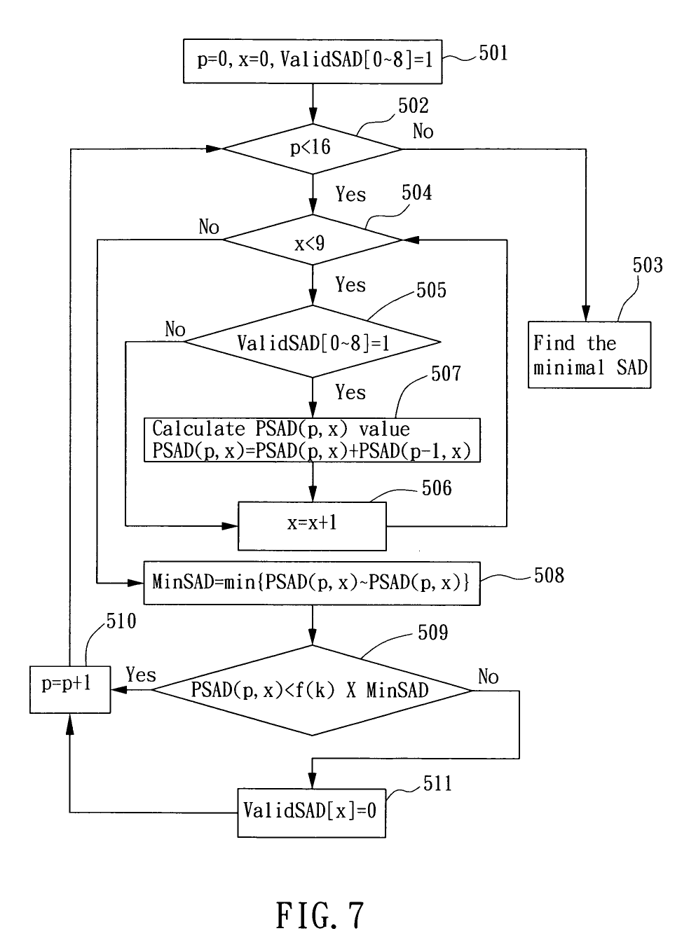

FIG. 7 is a flow chart depicting the block matching method combining the diamond search algorithm with factor decision. In the flow chart, p represents the amount of pixel calculation processed in an MB, x represents the location of the MB in the diamond search, PSAD(p,x) represents the sum of PSADs of previous p iterations at location x, MinSAD represents the smallest PSAD(p,x) in the diamond formation at p iteration, ValidSAD[x] is used to represent whether x location is valid as a candidate or not, and is determined based on PSAD(p,x), and k represents the number of calculation which is the same as p. The process begins at block 501. At block 501, let p=0, x=0, ValidSAD[0˜8]=1, where the value 1 represent valid, 0 represents invalid, since a 16×16 MB is used for searching a diamond formation of 9 points.

At decision block 502, an evaluation is made to determine whether the number of PSAD calculation is smaller than 16. The reason is that there will be no more than 16 PSAD calculations for every valid location of the diamond formation. That is, there are at most 16 PSADs for each valid location. Therefore, when p=16, the location among the diamond formation of 9 points that has the smallest SAD had to be spotted. If p<16, the process proceeds from decision block to decision block 504; otherwise, the process proceeds to block 503. At block 503, the process ends, i.e. the location with minimal SAD is found. At decision block 504, an evaluation is made to determine whether x is smaller than 9. If so, it represents that the PSAD calculation for every valid points in the diamond formation is not yet finished and the process proceeds to decision block 505; otherwise, the process proceeds from decision block 502 to block 508. At decision block 505, an evaluation is made to determine whether the current x location is valid or not according to the restriction criteria set by factor decision or sort decision algorithm. If x location is determined to be valid, the process proceeds from decision block 505 to block 507; otherwise, the process proceeds to block 506. At block 506, let x=x+1, i.e. starting to search the x+1 location, and the process returns to decision block 504. At block 507, an operation is made to calculate the value of PSAD(p,x), i.e. PSAD(p,x)=PSAD(p,x)+PSAD(p−1,x), and the process proceeds from block 507 to block 506.

At block 508, a comparison is made between PSAD(p,x) of every x to select the smallest PSAD from those PSAD(p,x) as the MinSAD and the process proceeds from block 508 to decision block 509. At decision block 509, a threshold SAD is set to be f(k)×MinSAD such that an evaluation is made to determine whether PSAD(p,x) is smaller than the threshold SAD. If so, then the process proceeds from decision block 509 to block 510; otherwise, the process proceeds to block 511. At block 510, let p=p+1. That is, it represents that the process will go on to the next PSAD calculation, and then the process returns to decision block 502. At block 511, an operation is made to set the x location as invalid by setting ValidSAD[x]=0, and then the process proceeds from block 511 to block 510.

Except for the factor decision algorithm, the present invention also provides a block matching method combining the diamond search algorithm with a sort decision algorithm. The sort decision algorithm is featuring as follows: while performing PSAD calculation on every location of the diamond formation of 9 points, the process will sort the resulting PSADs in sequence and only select the locations with smaller PSAD as the valid candidate for the next PSAD calculation.

Therefore, the block matching method combining the diamond search algorithm with a sort decision algorithm or a factor decision algorithm can greatly reduce the amount of calculation needed for every candidate in an MB and also decrease the amount of valid candidates in the MB during video compression. In this regard, the present invention can greatly reduce the volume of calculation needed for video compression as well as the search time of the same.

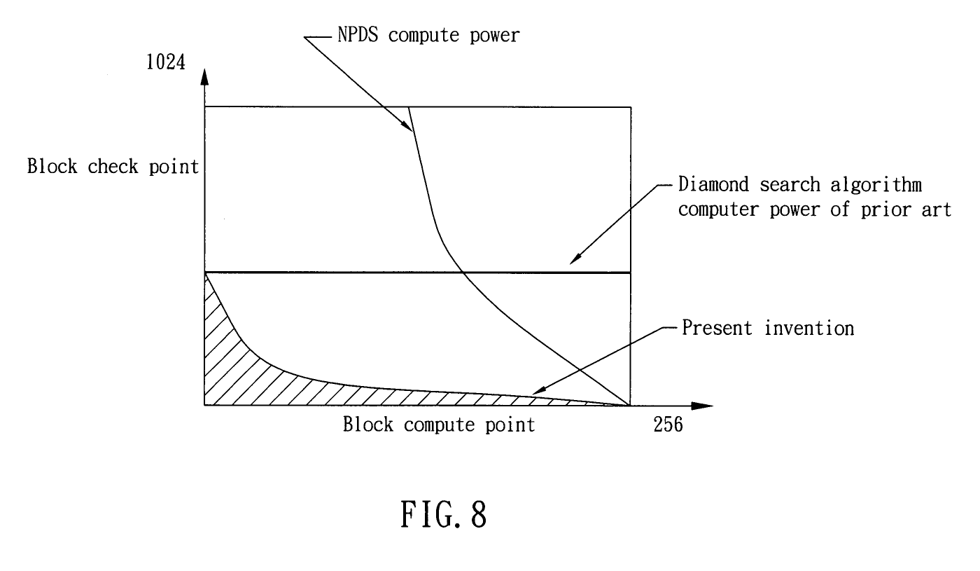

FIG. 8 is a graph showing the comparison of calculation volume between the present invention and prior art. As seen in FIG. 8, the areas for MB search and computing points in the MB of the present invention are less than those of the NPDS and the diamond search algorithm. Thus, the present invention indeed requires less calculation than the prior art.

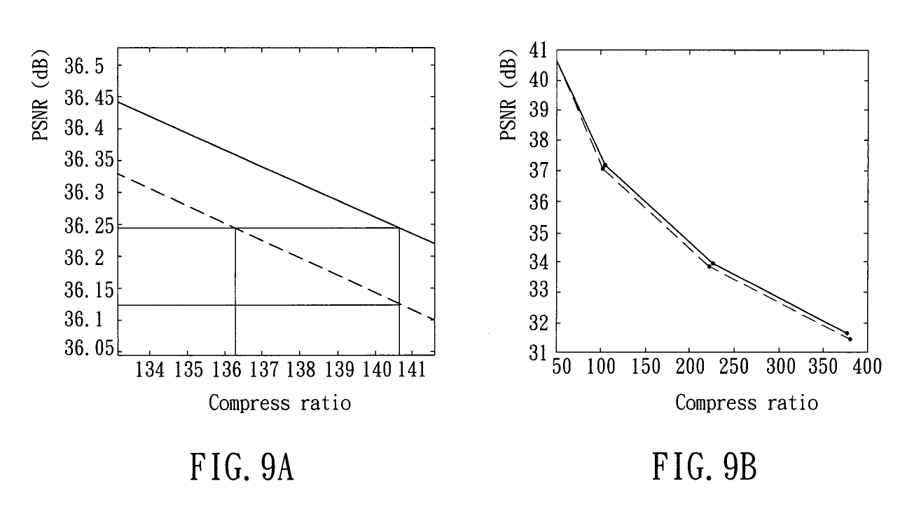

In addition, according to the experimental results, the present invention can still maintain a peak signal to noise ratio (PSNR) while effectively reducing the search time for finding the best matched MB. FIG. 9A and FIG. 9B are diagrams showing compression ratio v.s. PSNR. Assuming that the video compression format is an intra frame and 299 prediction frames. The solid line represents the result of a diamond search algorithm and the dotted line represents the result of the present invention. As seen in FIGS. 9A and 9B, the PSNR difference between the present invention and the diamond search algorithm is only 0.17 dB under the same compression ratio, and the 300 video frames compressed by the present invention only occupy 23 bytes more than that of the diamond search algorithm under the same PSANR, i.e., 0.61 bits for each frame and 3% less in compression ratio.

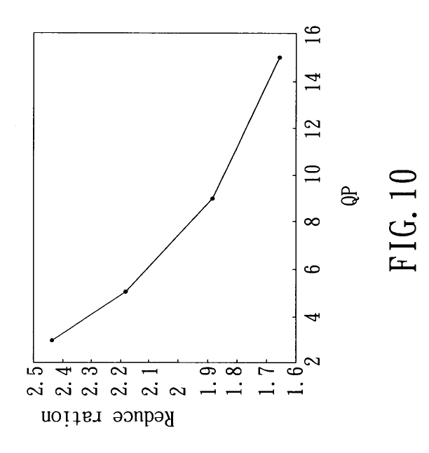

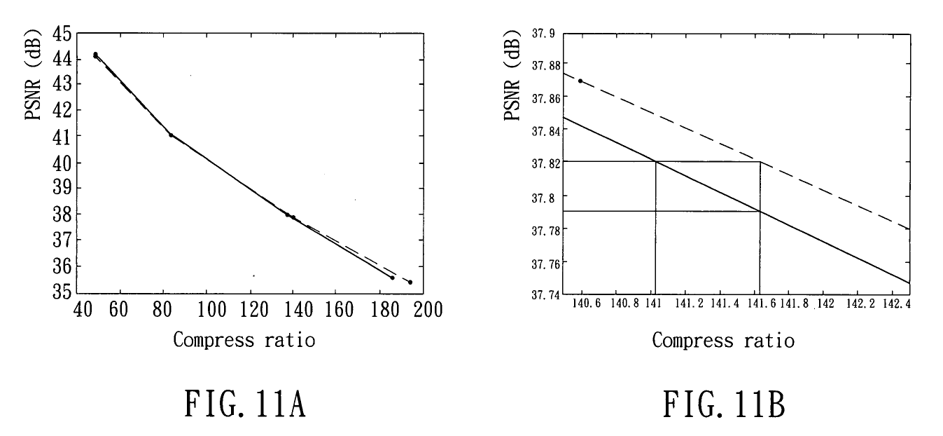

FIG. 10 is a schematic diagram illustrating quantization step (QP) and computing power. As the QP is 3, the calculation speed will be enhanced to 2.45 times of the original speed. As the QP is 15, the calculation speed will be enhanced to 1.65 times of the original speed. In a preferred embodiment of the present invention, the computing power reduction ratio is smaller while the QP is smaller. FIGS. 11A and 11B are respectively a diagram showing compression ratio v.s. PSNR of the present invention and a diagram showing compression ratio v.s. PSNR of the diamond search algorithm. The dotted line of the present invention is very close to the solid line of the diamond search while using 700 frames (VGA).

From the above description, it is clear that the present invention is capable of effectively reducing the amount of calculation required for searching the best matched MB, and decreasing the time needed for the search. At the same time, it maintains a preferred PSNR and compression ratio while comparing with the prior art. In addition, the present invention can reduce the consumption of computing power by enhancing the efficiency of calculation.

To sum up, the block matching method of the present invention uses a means of distributed access for performing PSAD calculation such that the profile of the resulting SAD is linear, and use a factor decision algorithm or sort decision algorithm for setting a restriction criteria such that the amount of PSAD calculations needed for getting the SAD of a MB is reduced. Consequently, it speeds up a candidate rejection process. Therefore, the present invention can reduce the amount of calculation and decrease search time while maintaining a prefer compress quality.

While the preferred embodiment of the present invention has been set forth for the purpose of disclosure, modifications of the disclosed embodiment of the present invention as well as other embodiments thereof may occur to those skilled in the art. Accordingly, the appended claims are intended to cover all embodiments, which do not depart from the spirit and scope of the present invention.

1. A block matching method for video compression, capable of finding a best matched macro block (MB) on a second frame prior to or after a first frame, based on a MB of the first frame, the method being characterized in that:
while simultaneously searching a plurality of points on the second frame, a threshold SAD is defined as multiplying a PSAD of smallest value among the plural points by a parameter for obtaining a threshold SAD to select a location among the plural points for next search;
wherein, the location for next search is the point with minimal SAD and can be found by rejecting the points with PSAD larger than threshold SAD and keeping the points with PSAD smaller than the threshold SAD.

2. The method as recited in claim 1, wherein the method comprising:
dividing the MB of the first frame into several subgroups each with the same amount of pixels distributed homogeneously therein;
numbering each subgroup and comparing the same with a specified location of a second frame according to the numbering so as to obtain the PSAD and eventually obtain a SAD by summing up all the PSAD of each number.

3. The method as recited in claim 2, wherein the method comprising:
applying the MB of the first frame on a first group of a second frame for detecting a second location with smallest SAD in the first group, wherein the first group is a diamond formation centering at a first location on the second frame;
applying the MB of the first frame on a second group for detecting a third location with smallest SAD in the second group, wherein the second group is a diamond formation centering at the second location; and
ending the proceeding of the method while the location with smallest SAD is the center of the current diamond formation.

4. The method as recited in claim 1, wherein the parameter is adjusted based on a search speed, and the faster the search speed is, the smaller the parameter is, and vice versa.

5. The method as recited in claim 2, wherein the PSAD is calculated based on a SAD formula.

6. The method as recited in claim 3, wherein the method comprising:
applying the MB of the first frame on the first group and the second group at the same time.

7. A block matching method for video compression, capable of finding a best matched MB on a second frame, which is prior to or after a first frame, based on a MB of the first frame, the method characterized by that:
while simultaneously searching a plurality of points on the second frame, sorting a plural PSADs calculated based on each location and accepting only a designated number of points with smaller PSAD as candidates for a next calculation.

8. The method as recited in claim 7, wherein the method comprising:
dividing the MB of the first frame into several subgroups each with the same amount of pixels distributed homogeneously therein;
numbering each subgroup and comparing the same with a specified location of a second frame according to the numbering so as to obtain the PSAD, and eventually obtain a SAD by summing up all the PSAD of each number.

9. The method as recited in claim 8, wherein the method comprising:
applying the MB of the first frame on a first group of a second frame for detecting a second location with smallest SAD in the first group, wherein the first group is a diamond formation centering at a first location on the second frame;
applying the MB of the first frame on a second group for detecting a third location with smallest SAD in the second group, wherein the second group is a diamond formation centering at the second location; and
ending the proceeding of the method while the location with smallest SAD is the center of the current diamond formation.

10. The method as recited in claim 8, wherein the designated number is adjusted dynamically.

11. The method as recited in claim 8, wherein the PSAD is calculated based on a SAD formula.

12. The method as recited in claim 8, wherein the method comprising: applying the MB of the first frame on the first group and the second group at the same time.
